(19) United States
(12) Patent Application Publication
(10) Pub. No.: US 2011/0193871 A1
(43) Pub. Date: Aug. 11, 2011

(54) RENDERING MULTI-LAYERED IMAGE

(75) Inventor: Sean E. Dunn, Austin, TX (US)

(73) Assignee: MICROSOFT CORPORATION, Redmond, WA (US)

(21) Appl. No.: 12/701,581

(22) Filed: Feb. 7, 2010

(51) Int. Cl. G09G 5/02

(52) U.S. Cl. 345/589

(57) ABSTRACT

A multi-layered image may be rasterized onto a background by considering each layer in the image from front to back. The alpha channel of a background buffer is cleared, so that it may act as an accumulator of total consumed opacity. Each image layer, from front to back, is then considered. For each layer, the layer's alpha value is multiplied by the complement of the alpha channel's current value, and the product is added to the background alpha channel. The background alpha channel is then multiplied by a global alpha value. The background color values are then pre-darkened by the complement of the resulting background alpha channel value. The background alpha channel is then cleared again, and the layers are rasterized and added, from front to back, onto the pre-darkened background, this time taking into consideration the per-layer color values.

### BACKGROUND

Images are often constructed in layers. Among the layers of images, an order is defined from front to back, and each layer may be associated with a particular opacity value, which is normally represented in the alpha channel. Thus, the final image that is built from the layers represents a blending of the different layers onto a background, where a given layer occludes the layers behind it, and the background, in an amount that is determined by the layer's opacity. Moreover, a global alpha value may be defined that affects the aggregate amount that the layers occlude the background. The process of rendering image layers onto a background is sometimes referred to as rasterization.

One way to rasterize layers onto a background is to render the layers, from back to front onto an intermediate target. The opacity of the intermediate target may then be scaled by the global alpha value—i.e., by multiplying the pixel values in the intermediate target by the global alpha value. The intermediate target may then be rasterized onto a background pattern or image. However, this technique may be inefficient.

### SUMMARY

In one example, image layers may be rasterized onto a background in the following manner. A background buffer, onto which the layers are to be rasterized, has an alpha channel. This alpha channel, while classically used to represent the opacity of the background buffer, can also be used as storage for the calculation of other values. The alpha channel is cleared. The alpha values of the image layers are then considered, in order, from frontmost to rearmost. The alpha value of the frontmost layer is examined first. The amount of opacity that remains to be allocated to the layers is then multiplied by the frontmost layer's alpha value, and the product is added to the background buffer's alpha channel. This process is then repeated for each of the layers from front to back. That is, for each layer, the amount of opacity that remains to be allocated is multiplied by that layer's alpha value, and the product is added to the alpha channel. In this way, the alpha channel acts as an accumulator for the amount of opacity that has been consumed by all of the layers that have been considered up to that point. By the time that all of the layers have been considered, the alpha channel stores the total amount of opacity consumed by the layers, (subject to scaling by the global alpha value). This total amount of consumed opacity is then multiplied by the global alpha value, and the product is the final amount of opacity consumed by the layers.

The complement of the final amount of opacity consumed by the layers is then allocated to the background. Thus, the background is pre-darkened in an amount equal to the complement of the amount of opacity consumed by the layers. The layers themselves are then rasterized onto the pre-darkened background. In order to perform this rasterization, the background buffer's alpha channel is once again cleared, so it may act as an accumulator for the amount of opacity consumed by the layers. The layers are then considered in order, from frontmost to rearmost. For each layer, the amount of opacity that remains to be allocated (i.e., the complement of the current value of the alpha channel) is multiplied by the current layer's alpha value. This product is then multiplied, for each pixel, by the color of the pixel, and the result is added to the corresponding pixel in the background. The product of the complement of the current value of the alpha channel and the current layer's alpha value is then added to the alpha channel. Each layer from front to back is then processed in this manner, until all of the layers have been considered. After all layers have been considered, the layers have been rasterized onto the background in a way that takes account of the individual alpha values of the layers and the global opacity. The resulting image then may be displayed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example scenario in which a multi-layered image may be rasterized onto a background.

FIG. 2 is a flow diagram of an example process in which one or more layers of an image may be rasterized onto a background.

FIG. 3 is a flow diagram of an example process to calculate an amount of opacity used by image layers.

FIG. 4 is a flow diagram of one example way to rasterize layers onto a background.

FIG. 5 is a block diagram of example components that may be used in connection with implementations of the subject matter described herein.

### DETAILED DESCRIPTION

Images to be rendered are often constructed in layers. A background is defined, and the image layers are then laid one on top of the other, such that the rearmost layer is rasterized directly on the background; the next layer forward is rasterized on top of the backmost layer; and so on, until the frontmost layer is rasterized on top of all of the preceding layers. An order may be defined among any set of layers, so that it is possible to know which is the rearmost layer, which is the next layer, and so on up to the frontmost layer.

In modern rendering systems, it is possible to define an opacity value for each layer, which is typically represented in an alpha channel. The alpha value specifies how opaque a given layer is. An alpha value of 0.0 represents 0% opacity (complete transparency). An alpha value of 1.0 represents 100% opacity. Often, layers have alpha values that lie somewhere in between those two extreme values. Additionally, a global alpha value may be defined that scales the opacity of all of the layers.

The amount that the background and each of the layers contributes to the final rasterized image is determined by the individual layers' alpha values and by the global alpha values. However, taking the various alpha values into account presents some complexities. For example, suppose that there is a global alpha value of 0.5, and there are ten layers with various alpha values ranging from 0.0 to 1.0. It would appear that one could apply the global alpha value to the overall image by multiplying the 0.5 global alpha value by each of the individual layers' alpha values. But the global alpha value is not distributive over the individual alpha values. Rather, it is applied after the relative opacity of the individual layers has been determined.

One way to render layers while accounting for the various alpha values is to render the individual layers from back to front onto an intermediate target, apply the global opacity to the intermediate target, and then render the intermediate target onto the background. However, this technique may be inefficient as it uses extra storage for the intermediate target.

The subject matter described herein provides an efficient way to render image layers onto a background. In one example, there is a background buffer that holds the background onto which layers of image are rasterized. The background buffer has an alpha channel, which may be used as an accumulator of alpha values in the following manner. An initial pass is made through the layers, from front to back, in order to determine how much opacity each layer will contribute to the final image. During this initial pass, the alpha channel of the background represents the amount of opacity that is consumed by all of the layers that have been considered up to that point. In the example where opacity is valued from 0.0 to 1.0, the total amount of opacity that is available to be allocated to the layers is 1.0. Thus, at the outset of the initial pass the alpha channel is cleared (i.e., set to 0.0); at that point, no layers have yet been considered, so none of the available opacity has been allocated to any of the layers. The layers are then traversed from front to back. For the first layer, the amount of available opacity (i.e., 1.0 minus the value of the alpha channel) is multiplied by that layer's opacity. This result is the amount of opacity that will be consumed by that layer, so the result is added to the alpha channel. The process is then repeated for the each subsequent layer from front to back. For example, suppose that the first two layers have alpha values of 0.3 and 0.5, respectively. When the first layer is considered, the alpha channel has a value of 0.0, so the amount of opacity remaining to be allocated is 1.0. So, the remaining opacity of 1.0 is multiplied by the first layer's alpha value of 0.3, which equal 0.3. Thus, 0.3 is added to the alpha channel. When the second layer is considered, the remaining alpha capacity is 0.7 (i.e., 1.0 minus 0.3). Thus, 0.7 is multiplied by the second layer's alpha value of 0.5, which equals 0.35. The second layer will consume 0.5 of the remaining opacity, which is 0.35 of the total amount of opacity (since 0.3 was already consumed by the first layer). Thus, after the first two layers have been considered, the total amount of opacity consumed is 0.65, which—at that point—is the value of the alpha channel. This process repeats until all layers from front to back have been considered. After all layers have been considered, the total amount of opacity consumed may be 1.0, or may be less than 1.0.

After all layers have been considered, the global alpha value is applied. Suppose that, after all layers have been considered, the background buffer's alpha channel has a value of 0.8, indicating that 0.8 of the alpha channel has been consumed by the individual layers. Suppose further that the global alpha value is 0.7. In that example, the global alpha value of 0.7 is multiplied by the alpha channel value of 0.8, yielding 0.56. The complement of this value is then used to pre-darken the background. What constitutes the complement depends on the numbering system that is used to represent opacity. If alpha values range from 0.0 to 1.0, then the complement of a value, X, is X subtracted from 1.0. In another example, if alpha values range from 0% to 100%, then the complement of a value Y is 100 minus Y. Thus, if the alpha channel has a value of 0.56 after the global alpha value is applied, then the complement is 0.44, so the background is pre-darkened with an opacity level of 0.44. In order to perform this pre-darkening, for each pixel in the background, the color of that pixel is multiplied by 0.44, and the result is written onto the background buffer. The background buffer's alpha channel is then cleared, so it may be used once again to accumulate alpha values for a second pass through the layers.

Another pass then may be made through the layers from front to back. For each pixel in the frontmost layer, the complement of the alpha channel is multiplied by that layer's alpha value and by the pixel's color. The result of this multiplication is then added to the background buffer's color at that pixel. It will be recalled that the background buffer was pre-darkened with the background image, so the result of this operation is to blend the background with the frontmost layer. The complement of the background buffer's alpha channel is then multiplied by the frontmost layer's alpha value, and the result is added to the background buffer's alpha channel. (As with the first pass, the background buffer's alpha channel acts as an accumulator of the aggregate amount of opacity consumed by the layers.) The process is then repeated for the next layer forward, and so on, until all of the layers from front to back have been considered. I.e., for the second layer, the complement of the current value of the alpha channel is multiplied by the second layer's alpha and the color of each pixel; the result, for each pixel, is then added to the current value of the corresponding pixel in the background buffer. The complement of the alpha channel's value is then multiplied by the second layer's alpha value, and the result is added to the alpha channel. And so on, through all of the layers, until all of the layers have been rasterized onto the background.

In one example, the background buffer may be a portion of memory built into a graphics card, although the subject matter herein is not limited to the use of any particular kind of hardware. Moreover, in one example, the technique described herein may avoid the use of an intermediate target onto which to render the layers; however, the subject matter herein may be implemented in any appropriate manner, regardless of whether an intermediate target is used.

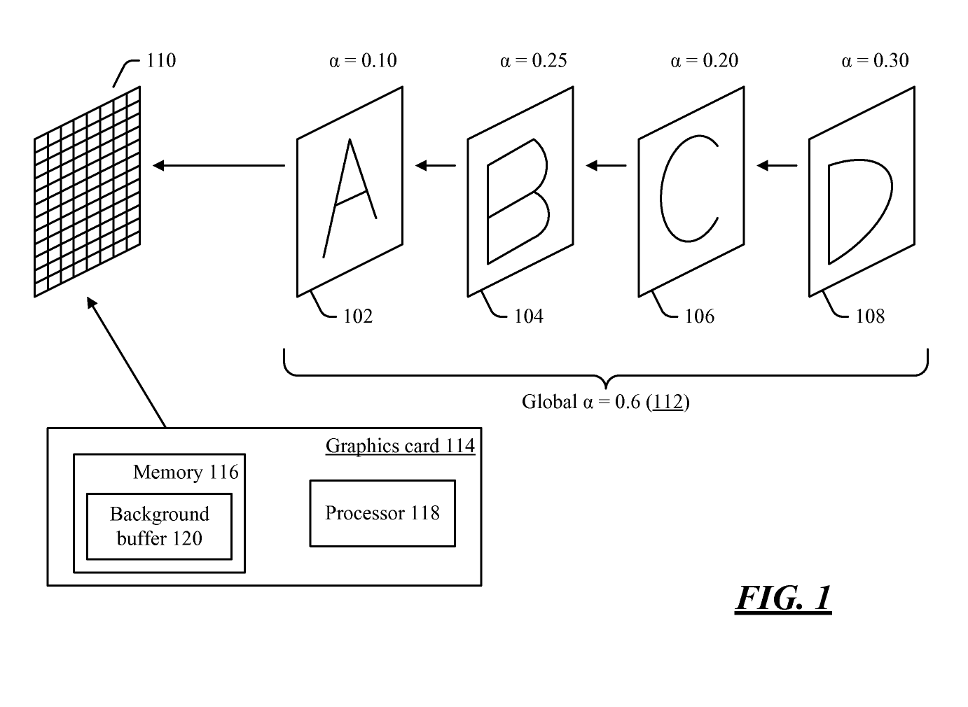

Turning now to the drawings, FIG. 1 shows an example scenario in which a multi-layered image may be rasterized onto a background. Layers 102, 104, 106 and 108 are separate layers of an image to be rasterized. In the example shown in FIG. 1, the images in each of these layers are the letters A, B, C, and D, respectively, although each layer could contain any type of image. Each layer is associated with an opacity (alpha) value. In particular, in the example shown layer 102 has an alpha value of 0.10; layer 104 has an alpha value of 0.25; layer 106 has an alpha value of 0.20; layer 108 has an alpha value of 0.30. Moreover, an order is defined among layers 102-108. That is, layer 108 is “in front of” (or “on top of”) layer 106, which is on top of layer 104, which is on top of layer 102. Thus, when layers 102-108 are rasterized, the final image will be some combination of the letters A, B, C, and D. The letters will partially occlude each other in a manner that is determined by the order of their respective layers, and by the relative opacity of those layers. In general, layers closer to the “front” (or “top”) will tend to occlude layers that are further toward the back. Moreover, for a given ordinal position of an image (i.e., frontmost, next to frontmost, etc.), the amount that the layer tends to occlude layers further behind is based on how much opacity is assigned to that layer. So, layer 108—having an alpha value of 0.30—will occlude layers 102-106 somewhat. But layer 108 would occlude those other layers in a greater amount if layer 108 had an alpha value of, say, 0.8. Conversely, layer 108 would occlude the other layers less if layer 108 had an alpha value of 0.1.

Background 110 is the rasterization target for layers 102-108. Thus, background 110 hold some type of image (e.g., a solid color, a pattern, a rasterized photograph, etc.), and layers 102-108 are rasterized onto that background.

A global alpha value 112 may be defined for the entire multi-layered image. As described above, the layers themselves consume some portion of the total available, and global alpha value 112 is a factor that scales the total amount of opacity consumed by the layers. Thus, if the total amount of opacity consumed by layers 102-108 is 0.4 and global alpha value 112 is 0.6, then 0.6 is multiplied by 0.4, yielding 0.24. In other words, if layers consume 0.4 of the available opacity and the global alpha value is 0.6, then the total amount of opacity consumed by the layers will be 0.24, leaving 0.76 of the total available opacity to be allocated to the background.

It is noted that the scenario shown in FIG. 1 may be implemented in any appropriate manner. However, one way to implement this scenario is on a graphics card 114. In particular, graphics card 114 may have a memory 116 and processor 118. Processor 118 may be used to perform various types of computation related to visual images. A portion of memory 116 may be used as a background buffer 120. Background buffer 120 has space to store pixels values. Rasterization of an image involves writing the correct values into the pixels of background buffer 120. Thus, each pixel in background buffer 120 may include space to store the various color components (e.g., red, green, and blue components in the RGB system, hue, saturation, and lightness in the HSL system, etc.), and may also contain space to store an opacity value. Such space to store an opacity value is the alpha channel mentioned above, which may be part of background buffer 120.

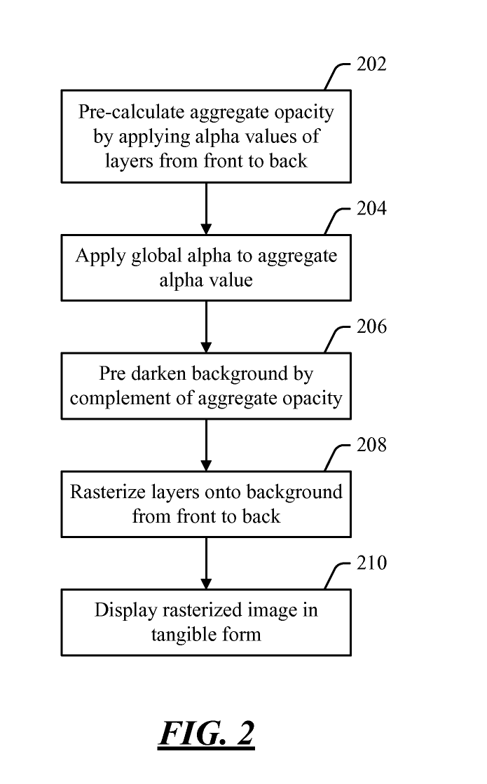

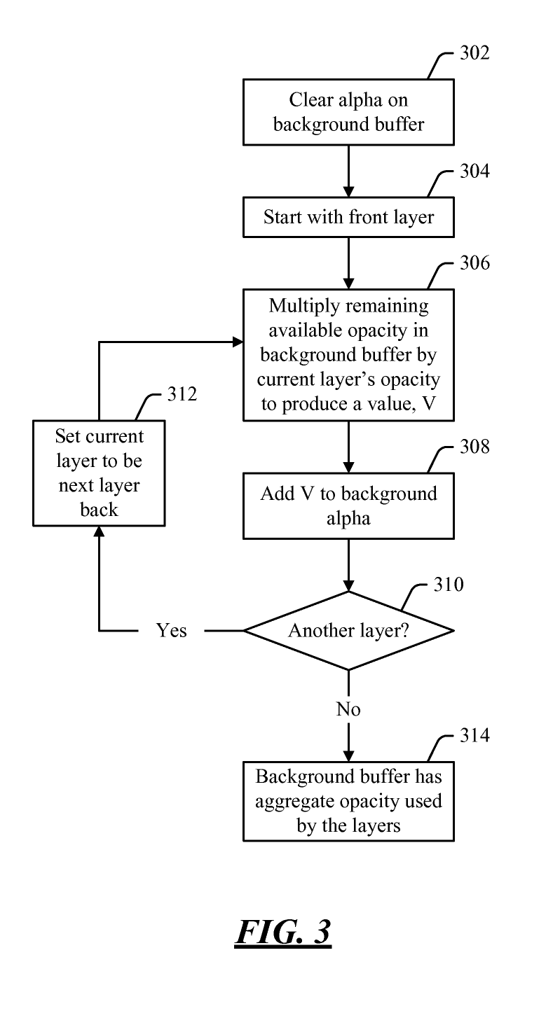

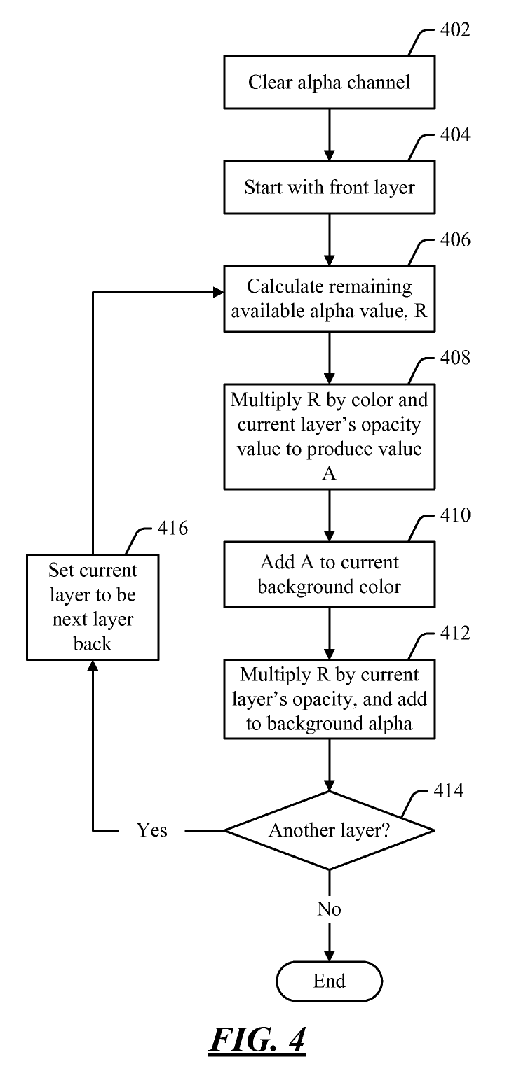

FIG. 2 shows an example process in which one or more layers of an image may be rasterized onto a background. Before turning to a description of FIG. 2, it is noted that the flow diagrams contained herein (both in FIG. 2 and in FIGS. 3-4) are described, by way of example, with reference to components shown in FIG. 1, although these processes may be carried out in any system and are not limited to the scenario shown in FIG. 1. Additionally, each of the flow diagrams in FIGS. 2-4 shows an example in which stages of a process are carried out in a particular order, as indicated by the lines connecting the blocks, but the various stages shown in these diagrams can be performed in any order, or in any combination or sub-combination.

At 202, the aggregate amount of opacity that is consumed by the various image layers is pre-calculated by applying the individual layers' alpha values from front to back. This aggregate amount of consumed opacity may be calculated in any manner. One way to calculate the amount of consumed opacity is shown in FIG. 3.

Turning now to FIG. 3, in order to calculate an amount of opacity consumed by the layers of an image, the alpha channel on a background buffer (or some other memory location that may be used as an accumulator of consumed opacity) is first cleared at 302. In the example where alpha values are represented on a scale of 0.0 (completely transparent) to 1.0 (completely opaque), clearing the alpha channel is done by setting the alpha channel to 0.0. The process then examines the alpha values in the image layers in an order proceeding from frontmost to backmost. Thus, the consideration of the different layers starts, at 304, with the frontmost layer, which is now the “current layer” in the process of FIG. 3. At 306, the remaining amount of opacity—as indicated by the alpha channel of the background buffer—is multiplied by the current layer's alpha value to produce a resulting value. For the purpose of describing FIG. 3, this resulting value is referred to as V. One way to calculate the remaining amount of alpha is to find the complement of the alpha channel's current value. The complement may be calculated as the difference between the maximum possible alpha value and the alpha channel's current value. Thus, in the case where the first layer is being considered, the alpha channel has a value of 0.0; 1.0 minus 0.0 is 1.0, so 1.0 is the amount of opacity that remains to be allocated. This remaining amount of opacity is multiplied by the currently layer's alpha value to produce the value V.

V represents the amount of opacity that will be consumed by the current layer. At 308, the value V is added to the background buffer's alpha channel. In other words, the alpha channel acts as an accumulator of the total amount of opacity that has been consumed by all of the layers that have been considered. In general, each layer consumes its alpha value times the total amount of opacity that remains to be allocated at the time the layer is considered.

At 310, it is determined whether there is another layer to consider. If so, then the current layer is set to the next layer back (at 312), and the process returns to 306 to consider the next layer. On the other hand, if there are no more layers to consider (i.e., if the current layer is the rearmost layer), then the background buffer now contains the aggregate amount of opacity used by all of the image layers (at 314).

Returning now to FIG. 2, once the aggregate amount of opacity has been calculated (by the process of FIG. 3, or by some other process), the global alpha value is applied to the aggregate amount of alpha (at 204), thereby producing an adjusted aggregate amount of alpha. Suppose, for example, that after considering all of the image layers, the total amount of opacity allocated to those layers is 0.55. Suppose further that the global alpha value is 0.75. In that case, the global alpha value (0.75) is multiplied by the total amount of opacity allocated to the layers (0.55), yielding 0.4125. In other words, the total amount of opacity that would naturally be consumed by the layers is found to be 0.55 (the initial aggregate amount of alpha), but this amount is reduced to 75% of its natural value since there is a global alpha value of 0.75. So, in view of the application of the global alpha value, the total amount of opacity that will be allocated to the layers is 0.4125 (the adjusted aggregate amount of alpha, which is derived from the initial aggregate amount of alpha). Since 0.4125 of the total available opacity is allocated to the layers, the remaining amount is the complement of 0.4125 (i.e., 0.5875). Since 0.5875 of opacity has not been allocated to the layers, it is allocated to the background. Thus, at 206, the background is pre-darkened by an amount specified by the complement of the aggregate opacity that has been allocated to the layers. Thus, in the example where 0.5875 of opacity is allocated to the background, the colors of the background pattern or image would be multiplied by 0.5875, and these values would be written to the appropriate pixels in the background buffer.

At 208, the layers of the image are rasterized from front to back onto the background. The layers may be rasterized onto the background in any appropriate manner. However, one example way to rasterize the layers onto the background is shown in FIG. 4.

Turning now to FIG. 4, at 402 the alpha channel for the background buffer is cleared. The alpha channel will, once again, act as an accumulator for the amount of alpha that has been consumed by the layers considered thus far. In order to act as such an accumulator, the alpha channel is first cleared at 402.

At 404, the frontmost layer is set to be the current layer. Portions of the process of FIG. 4 operate on a layer that is referred to in the diagram as the “current” layer. When the process of FIG. 4 first sets out to consider the layers, the frontmost layer is the “current” layer.

At 406, the remaining available amount of opacity is calculated. In FIG. 4, this remaining amount of opacity is given the label R. In one example, the remaining amount of opacity is the complement of the value of the alpha channel. Thus, when the first layer is being considered, the alpha channel has just been cleared, in which case the alpha channel's value is 0.0, so the remaining amount of opacity (R) is the complement of the alpha channel, i.e., 1.0.

At 408, for each pixel in the current layer, the color of the pixel is multiplied by the current layer's alpha value and by R in order to produce a value (which is labeled A in the diagram). The value A represents, for each pixel, the color that the current layer contributes to that pixel, scaled by the amount of opacity that has been allocated to the current layer. This value, A, is added to the color of the appropriate pixel in the background layer (at 410). Thus, the background layer now shows a blend of the background and the current layer.

During the process of FIG. 4, a running total of the amount of alpha consumed by each layer is kept—just as in the process of FIG. 3. Thus, at 412, the value R (described above) is multiplied by the current layer's alpha value, and the product is added to the background buffer's alpha channel. Thus, the background buffer's alpha channel represents the total amount of opacity that has been consumed by the layers that have been considered thus far.

At 414, it is determined whether there is another layer to consider. If so, then the current layer is set to be the next layer back (at 416), and the process returns to 406 to consider another layer. On the other hand, if there are no more layers to consider—i.e., if the current layer is the rearmost layer—then the process of FIG. 4 ends.

Returning now to FIG. 2, after the image layers have been rasterized, the rasterized image may be displayed in a tangible form at 210. For example, physical elements (e.g., pixels on a display) may be set or adjusted in the appropriate way in order to display a visual image to a user.

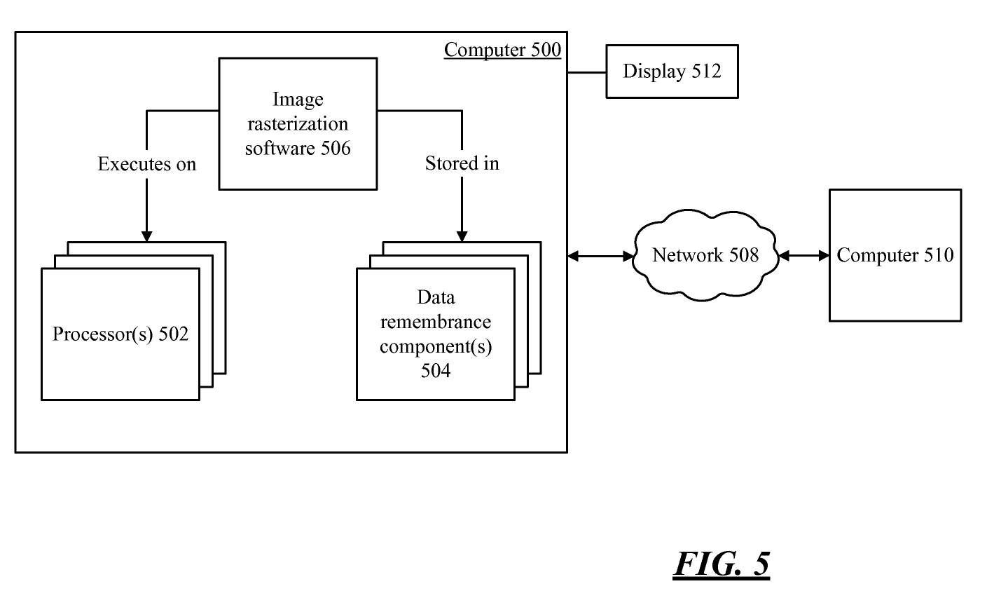

FIG. 5 shows an example environment in which aspects of the subject matter described herein may be deployed.

Computer 500 includes one or more processors 502 and one or more data remembrance components 504. Processor(s) 502 are typically microprocessors, such as those found in a personal desktop or laptop computer, a server, a handheld computer, or another kind of computing device. Data remembrance component(s) 504 are components that are capable of storing data for either the short or long term. Examples of data remembrance component(s) 504 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 500 may comprise, or be associated with, display 512, which may be a cathode ray tube (CRT) monitor, a liquid crystal display (LCD) monitor, or any other type of monitor.

Software may be stored in the data remembrance component(s) 504, and may execute on the one or more processor(s) 502. An example of such software is image rasterization software 506, which may implement some or all of the functionality described above in connection with FIGS. 1-4, although any type of software could be used. Software 506 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as instructions that are stored on one or more computer-readable storage media. Tangible media, such as an optical disks or magnetic disks, are examples of storage media. The instructions may exist on non-transitory media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 502) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 500 may be communicatively connected to one or more other devices through network 508. Computer 510, which may be similar in structure to computer 500, is an example of a device that can be connected to computer 500, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more non-transitory computer-readable media that store instructions to display a multi-layered image, wherein the instructions, when executed by a computer, cause the computer to perform first acts comprising:
calculating an aggregate amount of opacity consumed by layers of said image, each layer of said image being associated with an alpha value that indicates the layer's opacity;
applying a global alpha value to said aggregate amount of opacity to produce an adjusted aggregate amount of opacity;
pre-darkening a background by an amount specified by a first complement of said adjusted aggregate amount of opacity;
rasterizing each layer of said image onto said background to produce a rasterized image, wherein layers of said image are rasterized in an order proceeding from a frontmost layer to a rearmost layer; and
displaying said rasterized image.

2. The one or more non-transitory computer-readable media of claim 1, wherein said first acts are performed by a graphics card that comprises a background buffer, wherein said pre-darkening of said background is performed by setting values in said background buffer to those of a background image which is multiplied by said first complement of said adjusted aggregate amount of opacity, and wherein said rasterizing of each layer is performed by using each layer to set values in said background buffer.

3. The one or more non-transitory computer-readable media of claim 1, wherein said calculating of said aggregate amount of opacity consumed by layers of said image comprises:
setting a memory location to zero; and
for each layer, L, starting with the frontmost layer and proceeding toward the rearmost layer, performing second acts comprising:
calculating a second complement of a value of said memory location;
multiplying an alpha value associated with layer L by said second complement to produce a product; and
adding said product to said memory location.

4. The one or more non-transitory computer-readable media of claim 1, wherein said applying of said global alpha value comprises:
multiplying said global alpha value by said aggregate amount of opacity that is consumed by layers of said image.

5. The one or more non-transitory computer-readable media of claim 1, wherein said adjusted aggregate amount of opacity is a value between zero and one, with zero indicating complete transparency and one indicating complete opacity, and wherein said first complement is said adjusted aggregate amount of opacity subtracted from one.

6. The one or more non-transitory computer-readable media of claim 1, wherein said rasterizing comprises:
setting a memory location to zero; and
for each layer, L, performing second acts comprising:
calculating a second complement of a value of said memory location;
multiplying said second complement by an alpha value associated with layer L and by a color that is part of layer L, to produce a first product; and
applying said first product to said background.

7. The one or more non-transitory computer-readable media of claim 6, wherein said second acts further comprise:
multiplying said second complement by said alpha value associated with layer L to produce a second product; and
adding said second product to said memory location.

8. A system for displaying an image, the system comprising:
a processor;
a data remembrance component;
a display; and
an image rasterization component that is stored in said data remembrance component and that executes on said processor, wherein said image rasterization component calculates a first aggregate amount of opacity consumed by a plurality of layers of said image, pre-darkens a background in an amount specified by a first complement of a second aggregate amount of opacity that is derived from said first aggregate amount of opacity, that rasterizes each layer of said image, in an order proceeding from a frontmost layer to a rearmost layer, onto said background to produce a rasterized image, and that displays said rasterized image on said display.

9. The system of claim 8, wherein said second aggregate amount of opacity is said first aggregate amount of opacity.

10. The system of claim 8, wherein said image rasterization component derives said second aggregate amount of opacity by multiplying said first aggregate amount of opacity by a global alpha value.

11. The system of claim 8, further comprising a memory location, wherein said system calculates said first aggregate amount of opacity by setting said memory location to zero, and for each layer, L, starting with the frontmost layer and proceeding toward the rearmost layer, calculating a second complement of a value of said memory location, multiplying an alpha value associated with layer L by said second complement to produce a product, and adding said product to said memory location.

12. The system of claim 11, further comprising:
a graphics card that comprises a background buffer, wherein said memory location comprises an alpha channel of said background buffer.

13. The system of claim 8, wherein said image rasterization component rasterizes said layers of said image by setting a memory location to zero, and, for each layer, L, calculating a second complement of a value of said memory location, multiplying said second complement by an alpha value associated with layer L and by a color that is part of layer L, to produce a first product, and applying said first product to said background.

14. The system of claim 13, wherein said image rasterization component, for each layer L, multiplies said second complement by said alpha value associated with layer L to produce a second product, and adds said second product to said memory location.

15. A method of rasterizing a multi-layered image, the method comprising:
using a processor to perform first acts comprising:
calculating a first aggregate amount of opacity consumed by layers of said image, each layer of said image being associated with an alpha value that indicates the layer's opacity;
pre-darkening a background by an amount specified by a first complement of a second aggregate amount of opacity that is based on said first aggregate amount of opacity;
rasterizing each layer of said image onto said background to produce a rasterized image; and
displaying said rasterized image.

16. The method of claim 15, wherein said first acts further comprise:
applying a global alpha value to said first aggregate amount of opacity to produce said second aggregate amount of opacity.

17. The method of claim 15, wherein said calculating of said first aggregate amount of opacity comprises:
setting a memory location to zero; and
for each layer, L, starting with the frontmost layer and proceeding toward the rearmost layer, performing second acts comprising:
calculating a second complement of a value of said memory location;
multiplying an alpha value associated with layer L by said second complement to produce a product; and
adding said product to said memory location.

18. The method of claim 17, wherein said memory location comprises an alpha channel of a background buffer of a graphics card.

19. The method of claim 15, wherein said rasterizing each layer onto said background image comprises:
setting a memory location to zero; and
for each layer, L, performing second acts comprising:
calculating a second complement of a value of said memory location;
multiplying said second complement by an alpha value associated with layer L and by a color that is part of layer L, to produce a product; and
applying said product to said background.

20. The method of claim 19, wherein said memory location comprises an alpha channel of a background buffer of a graphics card.
